(19) United States
(12) Patent Application Publication
(10) Pub. No.: US 2021/0282079 A1
(43) Pub. Date: Sep. 9, 2021

(54) METHOD AND DEVICE FOR DETERMINING SYNCHRONIZATION SIGNAL BLOCK SSB TRANSMISSION MODE

(71) Applicant: GUANGDONG OPPO MOBILE TELECOMMUNICATION CORP., LTD., DONGGUAN (CN)

(72) Inventors: Zuomin WU, Dongguan (CN); Chuanfeng HE, Dongguan (CN)

(73) Assignee: GUANGDONG OPPO MOBILE TELECOMMUNICATION CORP., LTD., DONGGUAN (CN)

(21) Appl. No.: 17/328,484

(22) Filed: May 24, 2021

Related U.S. Application Data
(63) Continuation of application No. PCT/CN2018/118788, filed on Nov. 30, 2018.

(51) Int. Cl. H04W 48/16; H04W 72/04; H04W 56/00; H04L 5/00

(52) U.S. Cl. CPC H04W 48/16; H04L 5/005; H04W 56/001; H04W 72/0446

(57) ABSTRACT

The present application provides a method and a device for determining an SSB transmission mode, which can achieve effective transmission of an SSB on an unlicensed spectrum. The method includes: determining a first SSB position based on an SSB transmission period, where the first SSB position is configured to transmit a first SSB; determining a second SSB position in candidate SSB positions within a discovery reference signal DRS window, where the second SSB position is configured to transmit a second SSB; and if the first SSB position and the second SSB position overlap in a time domain, determining an SSB transmission mode of an overlapped SSB position.

### CROSS-REFERENCE TO RELATED APPLICATIONS

This application is a continuation of International Application No. PCT/CN2018/118788, filed on Nov. 30, 2018, the content of which is hereby incorporated by reference in its entirety.

### TECHNICAL FIELD

Embodiments of the present application relate to the field of communications, and more particularly, to a method and a device for determining an SSB transmission mode.

### BACKGROUND

In a 5G system or a new radio (New Radio, NR) system, data transmission on an unlicensed spectrum is supported. Communication performed on the unlicensed spectrum needs to be based on a principle of Listen Before Talk (Listen Before Talk, LBT). Namely, before signal transmission is performed on a channel over the unlicensed spectrum, channel detection needs to be performed first, and after channel usage right is obtained, the signal transmission can be performed.

In a discovery reference signal (Discovery Reference Signal, DRS) transmission window (DRS window for short) on the unlicensed spectrum, a plurality of candidate synchronization signal block (Synchronizing Signal/PBCH Block, SSB or SS/PBCH Block) positions may be configured, so a length of the DRS window may be greater than a length of an SSB transmission period, which may result in overlapping between an SSB position within the DRS window and the SSB position determined based on the SSB transmission period. In this case, how to ensure effective transmission of an SSB becomes a problem to be solved.

### SUMMARY

Embodiments of the present application provide a method and a device for determining an SSB transmission mode, which can achieve effective transmission of an SSB on an unlicensed spectrum.

According to a first aspect, a method for determining a synchronization signal block SSB is provided, including: determining a first SSB position based on an SSB transmission period, where the first SSB position is configured to transmit a first SSB; determining a second SSB position in candidate SSB positions within a discovery reference signal DRS window, where the second SSB position is configured to transmit a second SSB; and if the first SSB position and the second SSB position overlap in a time domain, determining an SSB transmission mode of an overlapped SSB position.

According to a second aspect, a method for determining a synchronization signal block SSB is provided, including: performing receiving or sending of an SSB according to a length of a discovery reference signal DRS window and an SSB transmission period.

According to a third aspect, a communication device is provided, where the communication device may execute the method according to the first aspect or any optional implementation of the First aspect. Specifically, the communication device may include functional modules for executing the method according to the first aspect or any possible implementation of the first aspect.

According to a fourth aspect, a communication device is provided, where the communication device may execute the method according to the second aspect or any optional implementation of the second aspect. Specifically, the communication device may include functional modules for executing the method according to the second aspect or any possible implementation of the second aspect.

According to a fifth aspect, a communication device is provided, which includes a processor and a memory, where the memory is configured to store a computer program, and the processor is configured to invoke and run the computer program stored in the memory, so as to execute the method according to the first aspect or any possible implementation of the first aspect.

According to a sixth aspect, a communication device is provided, which includes a processor and a memory, where the memory is configured to store a computer program, and the processor is configured to invoke and run the computer program stored in the memory, so as to execute the method according to the second aspect or any possible implementation of the second aspect.

According to a seventh aspect, a chip is provided, which is configured to implement the method according to the first aspect or any possible implementation of the first aspect. Specifically, the chip includes a processor, which is configured to invoke and run a computer program from a memory, so as to cause a device equipped with the chip to execute the method according to the first aspect or any possible implementation of the first aspect.

According to an eighth aspect, a chip is provided, which is configured to implement the method according to the second aspect or any possible implementation of the second aspect. Specifically, the chip includes a processor, which is configured to invoke and run a computer program from a memory, so as to cause a device equipped with the chip to execute the method according to the second aspect or any possible implementation of the second aspect.

According to a ninth aspect, a computer readable storage medium is provided, which is configured to store a computer program, and the computer program is configured to cause a computer to execute the method according to the first aspect or any possible implementation of the first aspect.

According to a tenth aspect, a computer readable storage medium is provided, which is configured to store a computer program, and the computer program is configured to cause a computer to execute the method according to the second aspect or any possible implementation of the second aspect.

According to an eleventh aspect, a computer program product is provided, including computer program instructions, the computer program instructions are configured to cause a computer to execute the method according to the first aspect or any possible implementation of the first aspect.

According to a twelfth aspect, a computer program product is provided, including computer program instructions, the computer program instructions are configured to cause a computer to execute the method according to the second aspect or any possible implementation of the second aspect.

According to a thirteenth aspect, a computer program is provided, which, when being run on a computer, causes the computer to execute the method according to the first aspect or any possible implementation of the first aspect.

According to a fourteenth aspect, a computer program is provided, which, when being run on a computer, causes the computer to execute the method according to the second aspect or any possible implementation of the second aspect.

According to a fifteenth aspect, a communication system is provided, including a communication device.

The communication device is configured to: determine a first SSB position based on an SSB transmission period, where the first SSB position is configured to transmit a first SSB; determine a second SSB position in candidate SSB positions within a discovery reference signal DRS window, where the second SSB position is configured to transmit a second SSB; and if the first SSB position and the second SSB position overlap in a time domain, determine an SSB transmission mode of an overlapped SSB position.

According to the above technical solutions, when a network device performs the sending of the SSB on the unlicensed spectrum, and the SSB position within the DRS window overlaps with the SSB position determined based on the SSB transmission period in the time domain, the network device determines the SSB transmission mode based on a predetermined condition, thereby implementing the effective transmission of the SSB, without constraining the length of the DRS window and the SSB transmission period.

### BRIEF DESCRIPTION OF DRAWINGS

FIG. 1 is a schematic view of a possible wireless communication system to which an embodiment of the present application is applied;

FIG. 2 is a schematic view of a DRS window and an SSB transmission period;

FIG. 3 is a schematic flowchart of a method for determining an SSB transmission mode according to an embodiment of the present application;

FIG. 4 is a schematic view of an SSB transmission mode according to an embodiment of the present application;

FIG. 5 is a schematic view of an SSB transmission mode according to an embodiment of the present application;

FIG. 6 is a schematic view of an SSB transmission mode according to an embodiment of the present application;

FIG. 7 is a schematic diagram of a communication device according to an embodiment of the present application;

FIG. 8 is a schematic flowchart of a method for determining an SSB transmission mode according to an embodiment of the present application;

FIG. 9 is a schematic structural diagram of a communication device according to an embodiment of the present application;

FIG. 10 is a schematic structural diagram of a communication device according to an embodiment of the present application;

FIG. 11 is a schematic structural diagram of a chip according to an embodiment of the present application;

FIG. 12 is a schematic structural diagram of a chip according to an embodiment of the present application; and

FIG. 13 is a schematic structural diagram of a communication system according to an embodiment of the present application.

### DESCRIPTION OF EMBODIMENTS

Hereinafter, technical solutions in embodiments of the present application will be described with reference to the accompanying drawings in the embodiments of the present application. Apparently, the described embodiments are a part of the embodiments of the present application, rather than all of the embodiments. Based on the embodiments of the present application, all other embodiments obtained by a person of ordinary skill in the art without paying creative efforts all belong to the protection scope of the present application.

The technical solutions in the embodiments of the present application may be applied to various communication systems, for example, a Global System of Mobile communication (GSM), a Code Division Multiple Access (CDMA) system, a Wideband Code Division Multiple Access (WCDMA) system, General Packet Radio Service (GPRS) system, a Long Term Evolution (LTE) system, an LTE Frequency Division Duplex (FDD) system, an LTE Time Division Duplex (TDD) system, an advanced long term evolution (LTE-A) system, a New Radio (NR) system, an evolution system of the NR system, an LTE (LTE-based access to unlicensed spectrum, LTE-U) system on an unlicensed spectrum, an NR (NR-based access to unlicensed spectrum, NR-U) system on the unlicensed spectrum, a Universal Mobile Telecommunication System (UMTS), a Worldwide Interoperability for Microwave Access (WiMAX) communication system, Wireless Local Area Networks (WLAN), Wireless Fidelity (WiFi), a next generation communication system, or other communication systems, etc.

In general, a quantity of connections supported by a conventional communication system is limited, and it is easy to implement. However, with development of communication technologies, a mobile communication system will not only support conventional communication, but also support, for example, Device to Device (D2D) communication, Machine to Machine (M2M) communication, Machine Type Communication (MTC), and Vehicle to Vehicle (V2V) communication, etc. The embodiments of the present application may also be applied to these communication systems.

In an embodiment, a communication system in the embodiments of the present application may be applied to scenarios such as Carrier Aggregation (Carrier Aggregation, CA), Dual Connectivity (Dual Connectivity, DC), and Standalone (Standalone, SA).

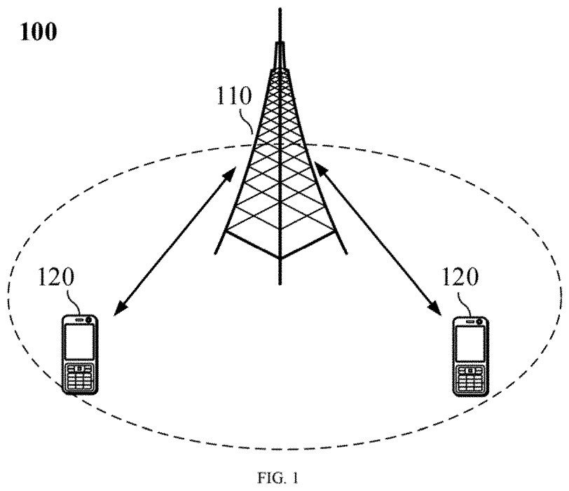

Illustratively, a communication system 100 to which an embodiment of the present application is applied may be shown in FIG. 1. The wireless communication system 100 may include a network device 110. The network device 110 may be a device in communication with a terminal device. The network device 110 may provide communication coverage for a specific geographic area and may communicate with the terminal device located within the coverage area. In an embodiment, the network device 110 may be a base station (Base Transceiver Station, BTS) in a GSM system or a CDMA system, it may also be a base station (Node B, NB) in a WCDMA system, it may also be an evolutional base station (Evolutional Node B, an eNB or an eNodeB) in an LTE system, or a network-side device in an NR system, or it may be a wireless controller in a Cloud Radio Access Network (CRAN), or the network device may be a relay station, an access point, a vehicle-mounted device, a wearable device, a network-side device in a next generation network, or a network device in a future evolved Public Land Mobile Network (PLMN), etc.

The wireless communication system 100 further includes at least one terminal device 120 within the coverage of the network device 110. The terminal device 120 may be mobile or fixed. In an embodiment, the terminal device 120 may refer to an access terminal, a user equipment (UE), a user unit, a user station, a mobile station, a mobile platform, a remote station, a remote terminal, a mobile device, a user terminal, a terminal, a wireless communication device, a user proxy, or a user apparatus. The access terminal may be a cellular telephone, a cordless telephone, a Session Initiation Protocol (SIP) telephone, a Wireless Local Loop (WLL) station, a Personal Digital Assistant (PDA), a handheld device having a function of wireless communication, a computing device or other processing devices connected to a wireless modem, a vehicle-mounted device, a wearable device, a terminal device in a future 5G network, or a terminal device in the future evolved PLMN, etc. In an embodiment, Device to Device (D2D) communication may be performed between terminal devices 120.

The network device 110 may provide services for a cell, and the terminal device 120 communicates with the network device 110 through transmission resources (such as frequency domain resources, or spectrum resources) used by the cell. The cell may be a cell corresponding to the network device 110 (for example, a base station). The cell may belong to a macro base station or a base station corresponding to a small cell (Small cell). The small cell here may include, for example, a metro cell (Metro cell), a micro cell (Micro cell), a pico cell (Pico cell), and a femto cell (Femto cell). These small cells have characteristics of small coverage and low transmit power. It is applicable to provide high rate data transmission services.

FIG. 1 shows one network device and two terminal devices illustratively. In an embodiment, the wireless communication system 100 may include a plurality of network devices and other quantity of terminal devices may be included in the coverage of each network device, which is not limited in the embodiment of the present application. In addition, the wireless communication system 100 may further include other network entities such as a network controller and a mobile management entity, which is not limited in the embodiment of the present application.

Hereinafter, a position that can be configured to transmit an SSB is simply referred to as “an SSB position”, and one SSB can be transmitted at each SSB position.

In an embodiment, the SSB may include a primary synchronization signal (PSS) and a secondary synchronization signal (SSS) and a physical broadcast channel (PBCH).

In an embodiment, a DRS window may be configured to transmit the SSB, and may also be configured to transmit at least one of the following information: a control channel resource set for scheduling remaining minimum system information (RMSI), RMSI, a channel status information reference signal (CSI-RS), other system information (OSI), and a paging message.

On the unlicensed spectrum, the quantity of candidate SSB positions within one DRS window may be greater than the quantity of SSBs sent by the network device actually. For each DRS window, the network device may determine which SSB positions to be configured to transmit the SSBs according to a result of the channel usage right, for example, an LBT result obtained within the DRS window, and the SSB positions to transmit the SSBs actually within different DRS windows may be different.

There is a corresponding relationship between candidate SSB positions within the DRS window and SSB indexes. The SSB that can be sent at each candidate SSB position is not an arbitrary SSB, but rather an SSB indicated by an SSB index corresponding to the SSB position. There is a QCL relationship between the SSBs of the same index. The candidate SSB positions may be agreed by a protocol or configured by the network device.

In an embodiment, the SSBs with different indexes may also have the QCL relationship. The QCL relationship may be agreed by the protocol or configured by the network device. For example, the network device is configured to send four SSBs, where an SSB with an index 0 and an SSB with an index 4 have the QCL relationship, and an SSB with an index 1 and an SSB with an index 5 have the QCL relationship, etc.

In an embodiment, the quantity of SSB positions within the DRS window may be configured according to a size of subcarrier spacing. If the subcarrier spacing is 15 kHz, the candidate SSB positions within the DRS window are 16. If the subcarrier spacing is 30 kHz, the candidate SSB positions within the DRS window are 32. If the subcarrier spacing is 60 kHz, the candidate SSB positions within the DRS window are 64.

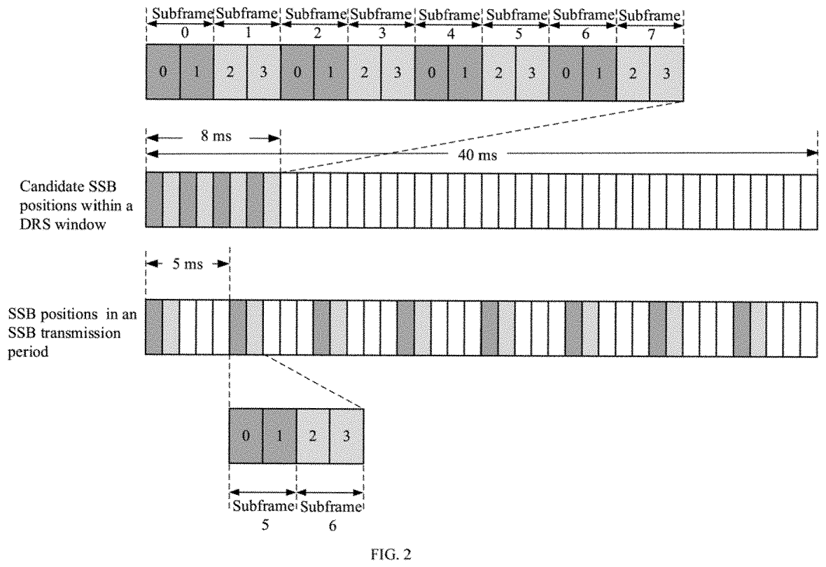

As shown in FIG. 2, a length of the DRS window is 8 ms, and a period of the DRS window is 40 ms, that is, first 8 ms of each 40 ms is one DRS window. One DRS window includes 8 subframes, that is, a subframe 0 to a subframe 7 as shown in FIG. 2, where each subframe includes two candidate SSB positions. Each candidate SSB position is marked with a number, and the SSB positions with the same number can be configured to send the SSBs with the same index, or the SSB positions with the same number can be configured to send the SSBs with the QCL (Quasi-Co-Location, QCL) relationship.

For example, in FIG. 2, an SSB position 0 corresponds to an SSB #0, therefore, each SSB position 0 is configured to send the SSB #0, or the SSBs sent on the SSB position 0 have the QCL relationship. An SSB position 1 corresponds to an SSB #1, therefore, each SSB position 1 is configured to send the SSB #1, or the SSBs sent on the SSB position 1 have the QCL relationship. An SSB position 2 corresponds to an SSB #2, therefore, each SSB position 2 is configured to send the SSB #2, or the SSBs sent on the SSB position 2 have the QCL relationship. An SSB position 3 corresponds to an SSB #3, therefore, each SSB position 3 is configured to send the IS SSB #3, or the SSBs sent on the SSB position 3 have the QCL relationship. Such corresponding relationships may be agreed by the protocol or configured by the network device. Each SSB is sent only at its corresponding SSB position, where #0 to #3 represent the SSB indexes.

Within the DRS window, the network device may send a corresponding SSB at the SSB position where the channel usage right is obtained. For example, the SSB #2 is sent at an SSB position 2 of a subframe 5, the SSB #3 is sent at an SSB position 3 of the subframe 5, the SSB #0 is sent at an SSB position 0 of a subframe 6, and the SSB #1 is sent at an SSB position 1 of the subframe 6.

However, when sending the SSB, the network device also needs to satisfy its transmission period, as shown in FIG. 2, the SSB transmission period is 5 ms, that is, in first 2 ms of each 5 ms, one round of SSBs (SSB #0 to SSB #3 are one round of SSBs) needs to be transmitted. The network device needs to perform sending of the SSBs based on the SSB transmission period, for example, the SSB #0 is sent at an SSB position 0 of the subframe 5, the SSB #1 is sent at an SSB position 1 of the subframe 5, the SSB #2 is sent at an SSB position 2 of the subframe 6, and the SSB #3 is sent at an SSB position 3 of the subframe 6.

The subframe 5 is taken as an example, it can be seen that, if according to the candidate SSB positions within the DRS window, the network device should send the SSB #2 and the SSB #3 at the SSB positions within the subframe 5 respectively however, if it is determined according to the SSB transmission period, the network device should send the SSB #0 and the SSB #1 at the SSB positions within the subframe 5 respectively. That is to say, when the length of the DRS window is greater than the length of the SSB transmission period, the SSB positions within the DRS window may overlap with the SSB positions determined based on the SSB transmission period, and the SSB positions within the DRS window and the SSB positions determined based on the SSB transmission period are configured to transmit SSBs with different indexes respectively. In this case, the network device needs to determine how to perform the sending of the SSB at an overlapped SSB position.

In the embodiments of the present application, when the network device performs the sending of the SSB on the unlicensed spectrum, and the SSB positions within the DRS window overlap with the SSB positions determined based on the SSB transmission period in a time domain, the network device determines an SSB transmission mode based on a predetermined condition, thereby implementing effective transmission of the SSB on the unlicensed spectrum and without constraining the length of the DRS window and the SSB transmission period.

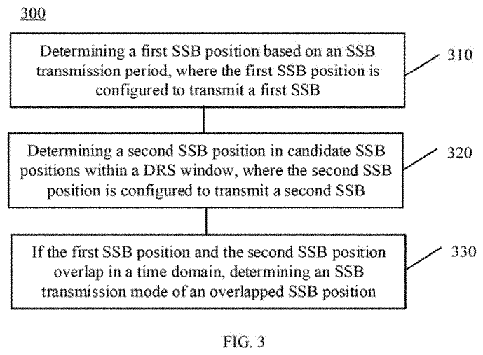

FIG. 3 is a schematic flowchart of a method 300 for determining an SSB transmission mode according to an embodiment of the present application. The method described in FIG. 3 may be executed by a communication device, and the communication device may include a network device or a terminal device. The network device may be, for example, the network device 110 shown in FIG. 1, and the terminal device may be, for example, the terminal device 120 shown in FIG. 1. As shown in FIG. 3, the SSB transmission method 300 may include some or all of the following steps. Where:

in 310, determining a first SSB position based on an SSB transmission period, where the first SSB position is configured to transmit a first SSB.

In 320, determining a second SSB position in candidate SSB positions within a DRS window, where the second SSB position is configured to transmit a second SSB.

In 330, if the first SSB position and the second SSB position overlap in a time domain, determining an SSB transmission mode of an overlapped SSB position.

On the unlicensed spectrum, when the network device sends the SSB, on the one hand, the transmission period based on the SSB needs to be considered, and on the other hand, the candidate SSB positions within the DRS window need to be considered. When a transmission opportunity is obtained, if the network device determines according to the SSB transmission period that the first SSB can be sent at the first SSB position, and determines that the second SSB can be sent at the second SSB position within the DRS window, then when the first SSB position and the second SSB position overlap, the network device needs to determine how to send the SSB at the overlapped SSB position.

Likewise, when receiving the SSB, the terminal device also needs to consider the transmission period of the SSB and the candidate SSB positions within the DRS window. If the terminal device determines according to the SSB transmission period that the first SSB is received at the first SSB position, and determines that the second SSB is received at the second SSB position within the DRS window, then when the first SSB position and the second SSB position overlap, the terminal device needs to determine how to receive the SSB at the overlapped SSB position.

It should be understood that, the first SSB position and the second SSB position overlap in the time domain described herein, which includes the first SSB position and the second SSB position overlap partially or overlap completely in the time domain.

In an embodiment, the first SSB position and the second SSB position overlap partially or overlap completely in a frequency domain.

In an embodiment, the first SSB position and the second SSB position do not overlap in the frequency domain and the first SSB position and the second SSB position are located within the same listening bandwidth in the frequency domain, where the listening bandwidth refers to a bandwidth of channel detection performed by the network device before the SSB is sent.

The present embodiment does not limit the length of the SSB transmission period, the length of the DRS window, and the period of the DRS window. The length of the SSB transmission period may be, for example, 5 milliseconds (ms), 10 ms, 20 ms, etc. The length of the DRS transmission window may be, for example, greater than 5 ms, for example, 6 ms, 7 ms, 8 ms and 9 ms, etc. The period of the DRS transmission window may be, for example, 40 ms, 80 ms, 160 ms, etc.

The embodiments of the present application provide five modes to determine how to perform the SSB transmission at the overlapped SSB position.

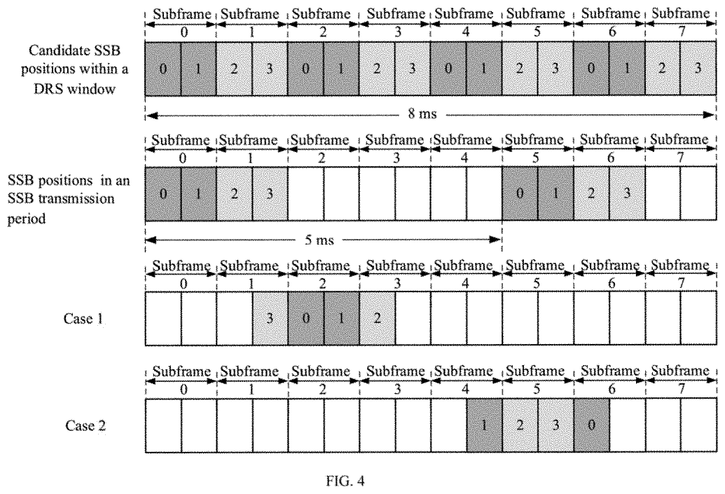

Hereinafter, description is made with reference to FIG. 4 to FIG. 7, and sending the SSB by the network device is merely taken as an example in FIG. 4 to FIG. 7, and if no special description is given, the process of receiving the SSB by the terminal device may refer to the relevant description of the network device.

### Mode 1

In 330, the determining the SSB transmission mode of the overlapped SSB position, including:

if transmission of at least one round of SSBs has been completed before the overlapped SSB position within the DRS window, determining that the overlapped SSB position is not configured to perform transmission of an SSB; and/or

if the transmission of the at least one round of SSBs has not been completed before the overlapped SSB position within the DRS window, determining that the overlapped SSB position is configured to transmit the second SSB.

In the embodiment, when the candidate SSB positions within the DRS window overlap with the SSB positions determined based on the SSB transmission period in the time domain, the network device may send the SSB according to the candidate SSB positions within the DRS window. Furthermore, the network device may determine whether it is necessary to send the SSB at the overlapped SSB position according to whether sending of the at least one round of SSBs has been completed before the overlapped SSB position. Correspondingly, when performing reception of the SSB, the terminal device may determine whether it is necessary to receive the SSB at the overlapped SSB position according to whether the reception of at least one SSB has been completed before the overlapped SSB position, or according to indication information for SSB sending situation within the DRS window of the network device.

FIG. 4 is taken as an example, it is assumed that the subcarrier spacing of the SSB is 15 kHz, the length of the DRS window is 8 ms, and the length of the SSB transmission period is 5 ms. The SSB positions with the same number may be configured to send the SSBs with the same index, or the SSB positions with the same number may be configured to send the SSBs with the QCL relationship. For example, the SSB position 0 is configured to send the SSB #0, the SSB position 1 is configured to send the SSB #l, the SSB position 2 is configured to send the SSB #2, and the SSB position 3 is configured to send the SSB #3.

Based on the candidate SSB positions within the DRS window, the network device may determine that two SSB positions of the subframe 5 are configured to send the SSB #2 and the SSB #3 respectively, and the two SSB positions of the subframe 6 are configured to send the SSB #0 and the SSB #1 respectively. Based on the SSB transmission period, the network device may determine that the two SSB positions of the subframe 5 are configured to send the SSB #0 and the SSB #1 respectively, and the two SSB positions of the subframe 6 are configured to send the SSB #2 and the SSB #3 respectively. That is, the overlapped SSB positions with different numbers include the SSB positions of the subframe 5 and the subframe 6.

Within the DRS window, if the sending of the at least one round of SSBs has been completed before the overlapped SSB positions, the network device may determine that the two SSB positions of the subframe 5 and the subframe 6 are not configured to send the SSBs, as shown in Case 1 of FIG. 4. Within the DRS window, if the sending of one round of SSBs has not been completed before the overlapped SSB position, the network device may send, according to the candidate SSB positions within the DRS window, the SSB #2 and the SSB #3 at the two SSB positions of the subframe 5 and send the SSB #0 at the first SSB position of the subframe 6, as shown in Case 2 of FIG. 4.

In an embodiment, the “one round of SSBs” in the embodiments of the present application is determined according to the quantity of the SSBs for sending configured by the network device. For example, as shown in FIG. 2, one round of SSBs may include the SSB #0 to the SSB #3. For another example, when the network device configures to send 8 SSBs, one round of SSB indexes may include the SSB #0 to the SSB #7.

### Mode 2

In 330, the determining the SSB transmission mode of the overlapped SSB position, including: determining that the overlapped SSB position is configured to transmit the second SSB.

In the embodiment, when the SSB positions determined based on the SSB transmission period overlap with the SSB positions determined based on the candidate SSB positions within the DRS window, the network device always sends the SSB according to the candidate SSB positions within the DRS window.

FIG. 5 is taken as an example, it is assumed that the subcarrier spacing of the SSB is 15 kHz, the length of the DRS window is 8 ms, and the length of the SSB transmission period is 5 ms. The SSB positions with the same number may be configured to send the SSBs with the same index, or the SSB positions with the same number may be configured to send the SSBs with the QCL relationship. For example, the SSB position 0 is configured to send the SSB #0, the SSB position 1 is configured to send the SSB #1, the SSB position 2 is configured to send the SSB #2, and the SSB position 3 is configured to send the SSB #3.

Based on the candidate SSB positions within the DRS window, the network device may determine that the two SSB positions of the subframe 5 are configured to send the SSB #2 and the SSB #3 respectively, and the two SSB positions of the subframe 6 are configured to send the SSB #0 and the SSB #1 respectively. Based on the SSB transmission period, the network device may determine that the two SSB positions of the subframe 5 are configured to send the SSB #0 and the SSB #1 respectively, and the two SSB positions of the subframe 6 are configured to send the SSB #2 and the SSB #3 respectively. That is, the overlapped SSB positions with different numbers include the SSB positions of the subframe 5 and the subframe 6.

In Case 1 of FIG. 5, the network device obtains an SSB transmission opportunity within the DRS window, where the transmission opportunity includes four SSB positions, which are located at the first SSB position of the subframe 5, the second SSB position of the subframe 5, the first SSB position of the subframe 6, and the second SSB position of the subframe 6 in turn. Before the overlapped SSB position, the network device has completed the sending of one round of SSBs.

In this case, the network device performs the sending of SSBs based on the candidate SSB positions within the DRS window, that is, the SSB #2 and the SSB #3 are sent in turn at the two SSB positions of the subframe 5, and the SSB #0 and the SSB #1 are sent in turn at the two SSB positions of the subframe 6.

In Case 2 of FIG. 5, the network device obtains the SSB transmission opportunity in the DRS window, where the transmission opportunity includes five SSB positions, which are located at the second SSB position of the subframe 4, the first SSB position of the subframe 5, the second SSB position of the subframe 5, the first SSB position of the subframe 6, and the second SSB position of the subframe 6 in turn. Before the overlapped SSB position, the network device has not completed the sending of one round of SSBs.

In this case, the network device still performs the sending of SSBs based on the candidate SSB positions within the DRS window, that is, the SSB #1 is sent at the SSB position of the subframe 4, the SSB #2 and the SSB #3 are sent in turn at the two SSB positions of the subframe 5, and the SSB #0 and the SSB #1 are sent in turn at the two SSB positions of the subframe 6.

### Mode 3

In 330, the determining the SSB transmission mode of the overlapped SSB position, including: determining that the overlapped SSB position is configured to transmit the first SSB.

In the embodiment, when the SSB positions determined based on the SSB transmission period overlap with the SSB positions determined based on the candidate SSB positions within the DRS window, the network device always sends the SSB according to the SSB transmission period.

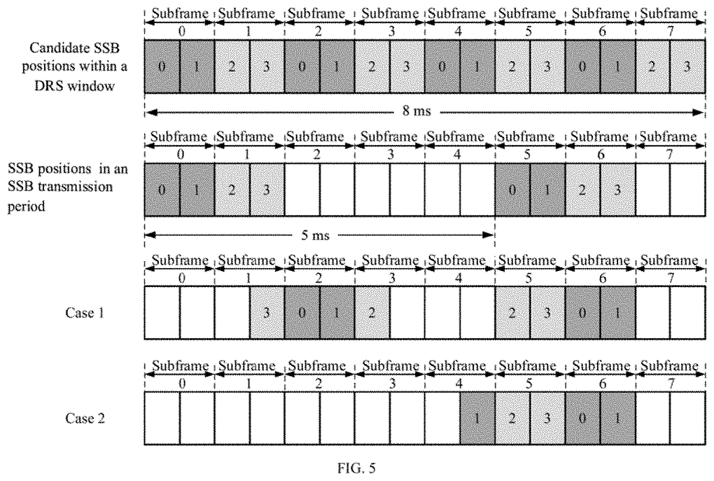

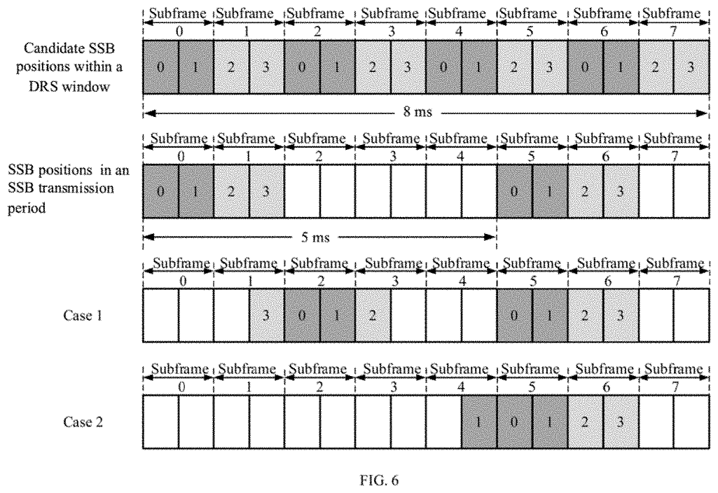

FIG. 6 is taken as an example, it is assumed that the subcarrier spacing of the SSB is 15 kHz, the length of the DRS window is 8 ms, and the length of the SSB transmission period is 5 ms. The SSB positions with the same number may be configured to send the SSBs with the same index, or the SSB positions with the same number may be configured to send the SSBs with the QCL relationship. For example, the SSB position 0 is configured to send the SSB #0, the SSB position 1 is configured to send the SSB #1, the SSB position 2 is configured to send the SSB #2, and the SSB position 3 is configured to send the SSB #3.

Based on the candidate SSB positions within the DRS window, the network device may determine that the two SSB positions of the subframe 5 are configured to send the SSB #2 and the SSB #3 respectively, and the two SSB positions of the subframe 6 are configured to send the SSB #0 and the SSB #1 respectively. Based on the SSB transmission period, the network device may determine that the two SSB positions of the subframe 5 are configured to send the SSB #0 and the SSB #1 respectively, and the two SSB positions of the subframe 6 are configured to send the SSB #2 and the SSB #3 respectively. That is, the overlapped SSB positions with different numbers include the SSB positions of the subframe 5 and the subframe 6.

In Case 1 of FIG. 6, the network device obtains the SSB transmission opportunity within the DRS window, where the transmission opportunity includes four SSB positions, which are located at the first SSB position of the subframe 5, the second SSB position of the subframe 5, the first SSB position of the sub frame 6, and the second SSB position of the subframe 6 in turn. Before the overlapped SSB position, the network device has completed the sending of one round of SSBs.

In this case, the network device performs the sending of SSBs based on the SSB transmission period, that is, the SSB #0 and the SSB #1 are sent in turn at the two SSB positions of the subframe 5, and the SSB #2 and the SSB #3 are sent in turn at the two SSB positions of the subframe 6.

In Case 2 of FIG. 6, the network device obtains the SSB transmission opportunity in the DRS window, where the transmission opportunity includes five SSB positions, which are located at the second SSB position of the subframe 4, the first SSB position of the subframe 5, the second SSB position of the subframe 5, the first SSB position of the subframe 6, and the second SSB position of the subframe 6 in turn. Before the overlapped SSB position, the network device has not completed the sending of one round of SSBs.

In this case, the network device performs the sending of SSBs based on the SSB transmission period, that is, the SSB #1 is sent at the SSB position of the subframe 4, the SSB #0 and the SSB #1 are sent in turn at the two SSB positions of the subframe 5, and the SSB #2 and the SSB #3 are sent in turn at the two SSB positions of the subframe 6.

### Mode 4

In 330, the determining the SSB transmission mode of the overlapped SSB position, including:

if transmission of at least one round of SSBs has been completed before the overlapped SSB position within the DRS window, determining that the overlapped SSB position is configured to transmit the first SSB; and/or

if the transmission of the at least one round of SSBs has not been completed before the overlapped SSB position within the DRS window, determining that the overlapped SSB position is configured to transmit the second SSB.

In the embodiment, when the candidate SSB positions within the DRS window overlap with the SSB positions determined based on the SSB transmission period in the time domain, the network device may determine how to send the SSB at the overlapped SSB position according to whether the sending of at least one round of SSBs has been completed before the overlapped SSB position. Correspondingly, when performing the reception of the SSB, the terminal device may determine how to receive the SSB at the overlapped SSB position according to whether the reception of at least one SSB has been completed before the overlapped SSB position, or according to the indication information for SSB sending situation within the DRS window of the network device.

For example, if the sending of the at least one round of SSBs has been completed before the overlapped SSB position, the overlapped SSB position is configured to send the second SSB. If the sending of the at least one round of SSBs has not been completed before the overlapped SSB position, the overlapped SSB position is configured to send the first SSB.

For another example, if the sending of the at least one round of SSBs has been completed before the overlapped SSB position, the overlapped SSB position is configured to send the first SSB. If the sending of the at least one round of SSBs has not been completed before the overlapped SSB position, the overlapped SSB position is configured to send the second SSB.

FIG. 7 is taken as an example, it is assumed that the subcarrier spacing of the SSB is 15 kHz, the length of the DRS window is 8 ms, and the length of the SSB transmission period is 5 ms. The SSB positions with the same number may be configured to send the SSBs with the same index, or the SSB positions with the same number may be configured to send the SSBs with the QCL relationship. For example, the SSB position 0 is configured to send the SSB #0, the SSB position 1 is configured to send the SSB #l, the SSB position 2 is configured to send the SSB #2, and the SSB position 3 is configured to send the SSW #3.

Based on the candidate SSB positions within the DRS window, the network device may determine that two SSB positions of the subframe 5 are configured to send the SSB #2 and the SSB #3 respectively, and the two SSB positions of the subframe 6 are configured to send the SSB #0 and the SSB #1 respectively. Based on the SSB transmission period, the network device may determine that the two SSB positions of the subframe 5 are configured to send the SSB #0 and the SSB #1 respectively, and the two SSB positions of the subframe 6 are configured to send the SSB #2 and the SSB #3 respectively. That is, the overlapped SSB positions with different numbers include the SSB positions of the subframe 5 and the subframe 6.

In Case 1 of FIG. 7, the network device obtains the SSB transmission opportunity in the DRS window, where the transmission opportunity includes four SSB positions, which are located at the first SSB position of the subframe 5, the second SSB position of the subframe 5, the first SSB position of the subframe 6, and the second SSB position of the subframe 6 in turn. Before the overlapped SSB position, the network device has completed the sending of one round of SSBs.

In this case, since the sending of the at least one round of SSBs has been completed before the overlapped SSB position, the network device performs the sending of SSBs based on the SSB transmission period, that is, the SSB #0 and the SSB #1 are sent in turn at the two SSB positions of the subframe 5, and the SSB #2 and the SSB #3 are sent in turn at the two SSB positions of the subframe 6.

In Case 2 of FIG. 7, the network device obtains the SSB transmission opportunity within the DRS window, where the transmission opportunity includes four SSB positions, which are located at the second SSB position of the subframe 4, the first SSB position of the subframe 5, the second SSB position of the subframe 5, and the first SSB position of the subframe 6 in turn. Before the overlapped SSB position, the network device has not completed the sending of one round of SSBs.

In this case, since the sending of the at least one round of SSBs has not been completed before the overlapped SSB position, the network device performs the sending of SSBs based on the candidate SSB positions within the DRS window, that is, the SSB #1 is sent at the SSB position of the subframe 4, the SSB #2 and the SSB #3 are sent in turn at the two SSB positions of the subframe 5, and the SSB #0 is sent at the first SSB position of the subframe 6.

### Mode 5

In 330, the determining the SSB transmission mode of the overlapped SSB position, including:

if the first SSB and the second SSB do not have the same QCL relationships, determining that the overlapped SSB position is not configured to perform sending of the SSB; and/or

if the first SSB and the second SSB have the same QCL relationship, or the first SSB and the second SSB have a QCL relationship, determining that the overlapped SSB position is configured to send the first SSB or the second SSB.

In the embodiment, when the candidate SSB positions within the DRS window overlap with the SSB positions determined based on the SSB transmission period in the time domain, the network device may determine how to send the SSB at the overlapped SSB position according to whether the first SSB and the second SSB have the same QCL relationship. For example, if the first SSB and the second SSB have different QCL relationships, the overlapped SSB position may not be configured to perform the SSB transmission. If the first SSB and the second SSB have the same QCL relationship, the overlapped SSB position may be configured to transmit the first SSB or the second SSB.

The first SSB and the second SSB have the same QCL relationship, for example, both the first SSB and the second SSB have QCL relationships with the same SSB, or the first SSB and the second SSB have the QCL relationship. The first SSB and the second SSB have different QCL relationships, for example, the first SSB and the second SSB have QCL relationships with different SSBs, or the first SSB and the second SSB do not have a QCL relationship. The SSBs having the QCL relationship may be, for example, SSBs sent using the same beam.

Therefore, in the embodiments of the present application, when the network device performs the sending of the SSB on the unlicensed spectrum, and the SSB positions within the DRS window overlap with the SSB positions determined based on the SSB transmission period in a time domain, the network device determines a sending mode of the SSB based on the predetermined condition, thereby implementing the effective transmission of the SSB and without constraining the length of the DRS window and the SSB transmission period.

It should be understood that, the candidate SSB positions within the DRS window in the embodiments of the present application may be configured to transmit the SSBs, and in some cases, may also be configured to transmit other information, for example, may be configured to transmit the remaining minimum system information (RMSI), the channel status information reference signal (CSI-RS), the other system information (OSI), the paging message, the physical downlink control channel (PDCCH) or the physical downlink shared channel (PDSCH), etc.

FIG. 8 is a schematic flowchart of a method for determining an SSB transmission mode according to an embodiment of the present application. The method described in FIG. 8 may be executed by a communication device, and the communication device may include a network device or a terminal device. The network device may be, for example, the network device 110 shown in FIG. 1, and the terminal device may be, for example, the terminal device 120 shown in FIG. 1. As shown in FIG. 8, the SSB transmission method 800 may include some or all of the following steps. Where:

in 810, performing receiving or sending of an SSB according to a length of a discovery reference signal DRS window and an SSB transmission period.

On an unlicensed spectrum, when the network device and the terminal device sends and receives the SSB, on the one hand, an SSB transmission period needs to be considered, and on the other hand, candidate SSB positions within the DRS window need to be considered. If it is determined based on the SSB transmission period that a first SSB position is configured to transmit a first SSB, and it is determined, at SSB candidate positions within the DRS window, that a second SSB position is configured to transmit a second SSB, then in order to enable the first SSB position and the second SSB position do not overlap, the lengths of the SSB transmission period and the DRS window may be configured reasonably.

It should be understood that, the first SSB position and the second SSB position overlap in the time domain described herein, which includes the first SSB position and the second SSB position overlap partially or overlap completely in the time domain.

In an embodiment, the first SSB position and the second SSB position overlap partially or overlap completely in a frequency domain.

In an embodiment, the first SSB position and the second SSB position do not overlap in the frequency domain and the first SSB position and the second SSB position are located within the same listening bandwidth in the frequency domain, where the listening bandwidth refers to a bandwidth of channel detection performed by the network device before the SSB is sent.

For example, as shown in FIG. 2, when the length of the DRS window is 8 ms and the length of the SSB transmission period is 5 ms, collision of SSB positions may occur.

In an embodiment, in an implementation, if the length of the DRS window is greater than 5 ms, the SSB transmission period satisfies:

a length of the SSB transmission period is not equal to 5 ms; or

the length of the SSB transmission period being equal to 5 ms is invalid configuration; or

the length of the SSB transmission period is greater than or equal to the length of the DRS window; or

SSB transmission of which the length of the SSB transmission period is equal to 5 ms is not performed within the DRS window.

Of course, resources of non-SSB candidate positions within the DRS window are not configured to the SSB transmission either.

In this case, the length of the DRS transmission window may be greater than 5 ms, for example, 6 ms, 7 ms, 8 ms, 9 ms, etc. The period of the DRS transmission window may be, for example, 40 ms, 80 ms, 160 ms, etc.

The length of the SSB transmission period may be, for example, 10 ms, 20 ms, etc.

In an embodiment, in another implementation, if the length of SSB transmission period is equal to 5 ms, the length of the DRS window satisfies:

the length of the DRS window is not greater than 5 ms; or

the length of the DRS window is greater than 5 ms and a part being greater than 5 ms is not configured to perform the SSB transmission within the DRS window.

In other words, when the length of the SSB transmission period is equal to 5 ms, the length of the DRS window may be less than or equal to 5 ms; or the length of the DRS window is greater than 5 ms, but the part being greater than 5 ms within the DRS window is not configured for the SSB transmission determined according to the candidate SSB positions within the DRS window, that is, an effective time length for transmitting the SSBs within the DRS window is 5 ms.

In an embodiment, the effective time length may be a continuous 5 ms at any time position within the DRS window.

Through the method, when the network device sends the SSBs on the unlicensed spectrum, it can be avoided that an overlap occurs in the time domain between SSB positions within the DRS window and the SSB positions determined based on the SSB transmission period.

An embodiment of the present application further provides a method for indicating an SSB, the method may include:

the network device sends a third SSB to the terminal device, where the third SSB carries half-frame indication information. Accordingly, the terminal device receives the half-frame indication information sent by the network device.

The half-frame indication information is configured to indicate half-frame information corresponding to a first candidate SSB position within the DRS window where the third SSB is located.

The half-frame information may be configured to, for example, for the terminal device to determine whether the third SSB belongs to the first half-frame (first 5 ms) or the last half-frame (last 5 ms) of a radio frame.

For example, assuming that the DRS window includes a subframe 0 to a subframe 7, if the third SSB is sent through an SSB candidate position within the DRS window, the half-frame indication information is configured to indicate the first half-frame (namely, the half-frame where the first candidate SSB position within the DRS window is located) regardless of whether the SSB candidate position is located in the first half-frame or the last half-frame. The terminal device may determine frame timing according to the half-frame where the first candidate SSB position is located and a current SSB index.

The half-frame indication information for example, may be carried in a PBCH of the third SSB.

An embodiment of the present application further provides another method for indicating an SSB. In an embodiment, a start position of the DRS window may be fixed to the first half-frame, in this case, the half-frame indication information may not be included in the PBCH received at the candidate SSB position within the DRS window. Further, in an embodiment, a bit for half-frame indication in the PBCH received at the SSB position may be configured to indicate other information, for example, to indicate the SSB position for sending the SSB within the DRS window actually.

Through the above method, effective indication of the SSB position can be achieved.

In the embodiments of the present application, considering uncertainty of obtaining the channel usage right on the unlicensed spectrum, the DRS window includes a plurality of candidate SSB positions, therefore a position where the SSB is transmitted actually within the DRS window on the unlicensed spectrum is also uncertain, and the network device needs to indicate to the terminal device the position where the SSB is transmitted within the DRS window on the unlicensed spectrum.

In a possible implementation, the network device selects a fourth SSB position within the DRS window with the channel usage right, and sends a fourth SSB on the fourth SSB position. The fourth SSB may include, for example, PSS, SSS, PBCH, etc. The PBCH includes first indication information, where the first indication information is configured to indicate an SSB position for sending at least one SSB in one round of SSBs in a plurality of candidate SSB positions within the DRS window. The terminal device may acquire the position where the SSB is transmitted actually according to the first indication information in the PBCH of the fourth SSB. In this way, the PBCH indicates the SSB position at which the SSB is transmitted actually, and dynamic indication of the SSB position can be achieved.

In an embodiment, the first indication information may include at least one of the following information:

an SSB position for transmitting at least one SSB in the round of SSBs among a plurality of candidate SSB positions within the DRS window;

a first SSB position for transmitting the SSB among the plurality of candidate SSB positions within the DRS window;

a last SSB position for transmitting the SSB among the plurality of candidate SSB positions within the DRS window;

an index of a first transmitted SSB among the plurality of candidate SSB positions within the DRS window;

an index of a last transmitted SSB among the plurality of candidate SSB positions within the DRS window;

a position of the first transmitted SSB in the round of SSBs among the plurality of candidate SSB positions within the DRS window;

a position of the last transmitted SSB in the round of SSBs among the plurality of candidate SSB positions within the DRS window; and

a position of the SSB transmitted at the fourth SSB position in the round of SSBs.

Or, in an embodiment, the first indication information includes a bitmap, and the bitmap includes a plurality of bits, and the plurality of bits have a one-to-one correspondence with the plurality of candidate SSB positions within the DRS window, where a value on each bit is configured to indicate whether a corresponding candidate SSB position is configured to send the SSB.

In the embodiment, the network device may indicate the position where the SSB is transmitted actually within a DRS transmission window flexibly through the first indication information, the terminal device is enabled to acquire the position where the SSB is transmitted actually within the DRS window according to the first indication information.

In addition, considering that the DRS window on the unlicensed spectrum may include the plurality of candidate SSB positions, accordingly, the DRS window on the unlicensed spectrum may also include a plurality of candidate channel state information reference signal (Channel State Information Reference Signals, CSI-RS) positions, and the position used for CSI-RS transmission actually within the DRS window has uncertainty. If a method for generating the CSI-RS sequence in the prior art is adopted, that is, an initialization parameter generated by the CSI-RS sequence is determined according to a symbol number occupied by the CSI-RS and a time slot number of a time slot where a symbol is located. Then, when the terminal device performs a radio resource management (Radio Resource Management, RRM) measurement of a neighboring cell based on the CSI-RS within the DRS window. It is also necessary to detect the symbol number occupied by the CSI-RS of the neighboring cell within the DRS window and the time slot number of the time slot where the symbol is located. Thus, complexity of an RRM measurement is greatly increased.

Therefore, an embodiment of the present application further provides a method for determining an initialization parameter generated by a CSI-RS sequence. The method may include:

the network device sends a first CSI-RS to the terminal device through a first time domain position within a DRS window, where the first CSI-RS is a CSI-RS generated according to a first initialization parameter. Accordingly, the terminal device receives the first CSI-RS sent by the network device.

In an embodiment, determination of the first initialization parameter is independent of the first time domain position.

In an embodiment, the first time domain position includes a symbol for transmission of the first CSI-RS and/or a time slot where the symbol for the transmission of the first CSI-RS is located.

In an embodiment, the first initialization parameter is determined according to an index of a fifth SSB, where the fifth SSB is an SSB associated with the first CSI-RS, or the fifth SSB has a QCL relationship with the first CSI-RS.

In an embodiment, the first initialization parameter is determined according to a second time domain position within the DRS window, where the second time domain position is preset in standard or configured for the terminal device by the network device. For example, the DRS window includes a plurality of candidate positions for transmitting the first CSI-RS. The network device may determine, according to the obtaining of the channel usage right, a candidate position (e.g. the first time domain position) from the plurality of candidate positions to send the first CSI-RS. The initialization parameter corresponding to the sequence of the first CSI-RS is determined according to the second time domain position. The second time domain position may be a preset candidate position (e.g. a first candidate position among the plurality of candidate positions or a last candidate position among the plurality of candidate positions) among the plurality of candidate locations. That is, no matter the first CSI-RS is sent through which candidate position among the plurality of candidate positions, the sequence of the first CSI-RS is the same and may be determined according to the second time domain position. Through the method, the terminal device may determine the sequence of the first CSI-RS within the DRS window in advance, and then detect the first CSI-RS within the DRS window.

The second time domain position includes a preset symbol and/or a preset time slot. For example, the second time domain position is a symbol of the first candidate position for the first CSI-RS within the DRS window, and/or a time slot where a symbol of the first candidate position for the first CSI-RS within the DRS window is located.

In the embodiment, a sequence generation mode of the CSI-RS sent by the network device within the DRS window may be independent of a symbol number occupied by actual transmission of the CSI-RS and a time slot number of the time slot where the symbol is located. Therefore, when the terminal device performs an RRM measurement of the neighboring cell based on the CSI-RS within the DRS window, it is not necessary to detect the symbol number occupied by the CSI-RS of the neighboring cell within the DRS window and the time slot number of the slot where the symbol is located. Thus, the complexity of the RRM measurement based on the CSI-RS within the DRS window on the unlicensed spectrum is avoided.

It should be noted that, without conflict, the embodiments and/or technical features of the embodiments described in the present application may be combined with each other arbitrarily, and the technical solutions obtained after a combination should also belong to the protection scope of the present application.

It should be understood that, the “SSB transmission” in the embodiments of the present application includes “sending of an SSB” and “reception of an SSB”. For example, when the method in the embodiment of the present application is executed by the network device, “transmit an SSB” may be understood as “send an SSB”, and when the method in the embodiment of the present application is executed by the terminal device, “transmit an SSB” may be understood as “receive an SSB”.

It should also be understood that, in various embodiments of the present application, the number of each process described above does not mean an execution order, and the execution order of each process should be determined according to its function and its intrinsic logic, and should not be limited to the execution process of the embodiments of the present application.

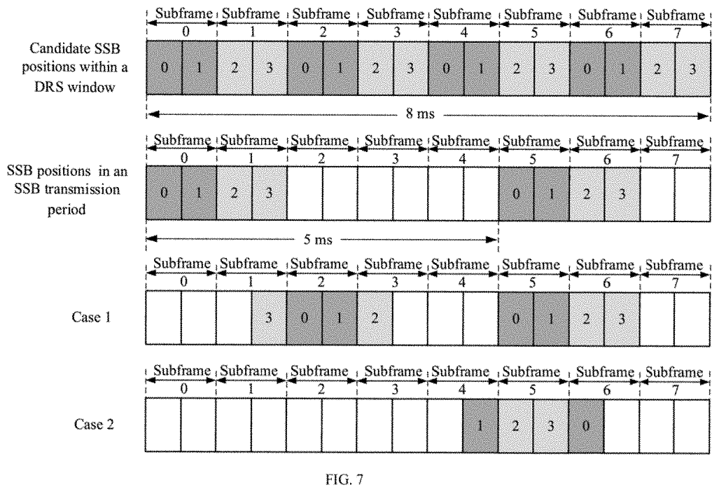

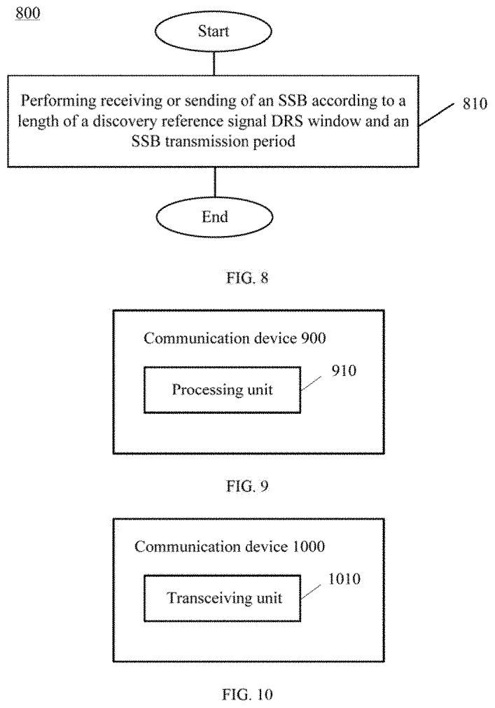

A communication method according to the embodiments of the present application is described in detail above, and a device according to the embodiments of the present application will be described below in conjunction with FIG. 9 to FIG. 13. The technical features described in the method embodiments are applicable to the following device embodiments.

FIG. 9 is a schematic structural diagram of a communication device 900 according to an embodiment of the present application, and the communication device 900 may be the terminal device or the network device. As shown in FIG. 9, the communication device 900 includes a processing unit 910, where the processing unit 910 may be configured to:

determine a first SSB position based on an SSB transmission period, where the first SSB position is configured to transmit a first SSB;

determine a second SSB position in candidate SSB positions within a Discovery Reference Signal DRS window, where the second SSB position is configured to transmit a second SSB; and

if the first SSB position and the second SSB position overlap in a time domain, determine an SSB transmission mode of an overlapped SSB position.

Therefore, when the network device performs sending of an SSB on an unlicensed spectrum, and SSB positions within the DRS window overlap with the SSB positions determined based on the SSB transmission period in the time domain, the network device determines a sending mode of the SSB based on a predetermined condition, thereby implementing effective transmission of the SSB and without constraining a length of the DRS window and the SSB transmission period.

In an embodiment, the processing unit 910 is specifically configured to: if sending of at least one round of SSBs has been completed before the overlapped SSB position within the DRS window, determine that the overlapped SSB position is not configured to perform sending of an SSB; and/or if the sending of the at least one round of SSBs has not been completed before the overlapped SSB position within the DRS window, determine that the overlapped SSB position is configured to send the second SSB.

In an embodiment, the processing unit 910 is specifically configured to: determine that the overlapped SSB position is configured to send the second SSB.

In an embodiment, the processing unit 910 is specifically configured to: determine that the overlapped SSB position is configured to send the first SSB.

In an embodiment, the processing unit 910 is specifically configured to: if sending of at least one round of SSBs has been completed before the overlapped SSB position within the DRS window, determining that the overlapped SSB position is configured to send the first SSB; and/or if the sending of the at least one round of SSBs has not been completed before the overlapped SSB position within the URS window, determining that the overlapped SSB position is configured to send the second SSB.

In an embodiment, the processing unit is specifically configured to: if the first SSB and the second SSB have different QCL relationships, determine that the overlapped SSB position is not configured to perform sending of an SSB; and/or if the first SSB and the second SSB have the same QCL relationship, determine that the overlapped SSB position is configured to send the first SSB or the second SSB.

In an embodiment, a length of the SSB transmission period is 5 ms.

In an embodiment, a length of the DRS window is greater than 5 ms.

It should be understood that, the communication device 900 can perform corresponding operations of the foregoing method 300. It is not described herein for simplicity.

FIG. 10 is a schematic structural diagram of a communication device 1000 according to an embodiment of the present application, and the communication device 1000 may be the terminal device or the network device. As shown in FIG. 10, the communication device 1000 includes a transceiving unit 1010, where the transceiving unit 1010 is configured to:

perform receiving or sending of an SSB according to a length of a discovery reference signal DRS window and an SSB transmission period.

Therefore, through the device, when the network device performs the sending of the SSB on the unlicensed spectrum, it can be avoided that an overlap occurs in the time domain between SSB positions within the DRS window and the SSB positions determined based on the SSB transmission period.

In an embodiment, if the length of the DRS window is greater than 5 ms, a length of the SSB transmission period is not equal to 5 ms, or a length of the SSB transmission period being equal to 5 ms is invalid configuration, or SSB transmission of which a length of the SSB transmission period is equal to 5 ms is not performed within the DRS window.

In an embodiment, the length of the DRS window is 6 ms, 7 ms, 8 ms or 9 ms.

In an embodiment, if a length of the SSB transmission period is equal to 5 ms, the length of the DRS window is not greater than 5 ms, or the length of the DRS window is greater than 5 ms and a part being greater than 5 ms is not configured to perform the sending of the SSB within the DRS window.

It should be understood that, the communication device 1000 can perform corresponding operations of the foregoing method 800. It is not described herein for simplicity.

FIG. 11 is a schematic structural diagram of a communication device 1100 according to an embodiment of the present application, and the communication device 1100 as shown in FIG. 11 includes a processor 1110. The processor 1110 may invoke and run a computer program from a memory to implement the method in the embodiments of the present application.

in an embodiment, as shown in FIG. 11, the communication device 1100 may further include a memory 1120. The processor 1110 may invoke and run the computer program from the memory 1120 to implement the method in the embodiments of the present application.

The memory 1120 may be a separate device which is independent of the processor 1110, or may be integrated in the processor 1110.

In an embodiment, as shown in FIG. 11, the communication device 1100 may further include a transceiver 1130, and the processor 1110 may communicate with other devices by controlling the transceiver 1130. Specifically, information or data may be sent to other devices, or information or data sent by other devices can be received.

The transceiver 1130 may include a transmitter and a receiver. The transceiver 1130 may further include an antenna, and the quantity of the antennas may be one or more.

In an embodiment, the communication device 1100 may specifically be a network device in the embodiments of the present application, and the communication device 1100 may implement corresponding processes implemented by the network device in various methods in the embodiments of the present application. It is not described herein for simplicity.

In an embodiment, the communication device 1100 may specifically be a terminal device or the network device in the embodiments of the present application, and the communication device 1100 may implement corresponding processes implemented by the terminal device in various methods in the embodiments of the present application. It is not described herein for simplicity.

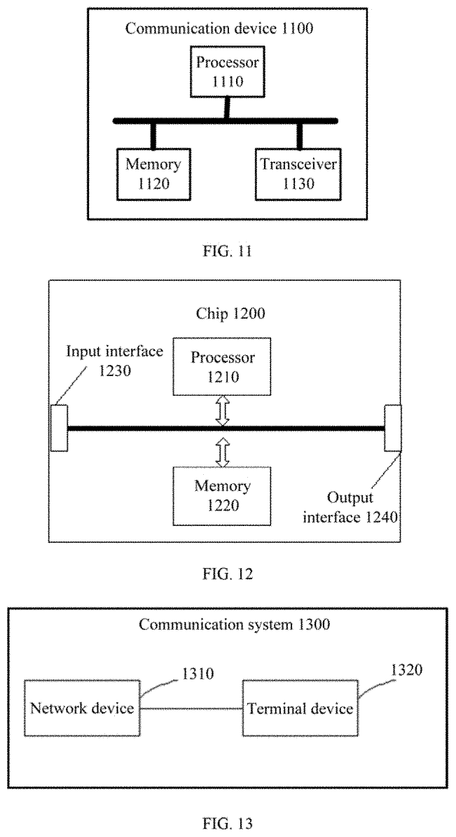

FIG. 12 is a schematic structural diagram of a chip according to an embodiment of the present application. The chip 1200 shown in FIG. 12 includes a processor 1210, where the processor 1210 may invoke and run a computer program from a memory to implement a method in an embodiment of the present application.

In an embodiment, as shown in FIG. 12, the chip 1200 may further include a memory 1220. The processor 1210 may invoke and run the computer program from the memory 1220 to implement the method in the embodiment of the present application.

The memory 1220 may be a separate device which is independent of the processor 1210, or may be integrated in the processor 1210.

In an embodiment, the chip 1200 may further include an input interface 1230. The processor 1210 may communicate with other devices or chips by controlling the input interface 1230. Specifically, information or data sent by other devices or chips may be acquired.

In an embodiment, the chip 1200 may further include an output interface 1240. The processor 1210 may communicate with other devices or chips by controlling the output interface 1240. Specifically, information or data may be output to other devices or chips.

In an embodiment, the chip may be applied to a network device in the embodiments of the present application, and the chip may implement corresponding processes implemented by the network device in various methods in the embodiments of the present application. It is not described herein for simplicity.

In an embodiment, the chip may be applied to a terminal device in the embodiments of the present application, and the chip may implement corresponding processes implemented by the terminal device in various methods in the embodiments of the present application. It is not described herein for simplicity.

It should be understood that, the chip mentioned in the embodiments of the present application may also be referred to as a system on chip, a system chip, a chip system or a system-on-chip chip, etc.

It should be understood that, the processor in the embodiments of the present application may be an integrated circuit chip having a capability of signal processing. In the implementation process, each step of the foregoing method embodiments may be completed by an integrated logic circuit of hardware in the processor or an instruction in a form of software. The processor may be a general processor, a digital signal processor (Digital Signal Processor, DSP), an application specific integrated circuit (Application Specific Integrated Circuit, ASIC), a field programmable gate array (Field Programmable Gate Array, FPGA) or other programmable logic devices, a discrete gate or a transistor logic device, and a discrete hardware component. The methods, steps and logical diagrams disclosed in the embodiments of the present application may be implemented or executed. The general processor may be a microprocessor or the processor may also be any conventional processor or the like. The steps of the method disclosed in the embodiments of the present application may be directly executed by a hardware decoding processor, or by a combination of the hardware and software modules in the decoding processor. The software modules may be located in a mature storage medium in the art, i.e. a random memory, a flash memory, a read-only memory, a programmable read-only memory, or an electrically erasable programmable memory, a register, etc. The storage medium is located in a memory, the processor reads information in the memory, and completes the steps of the above methods in combination with hardware thereof.

It should also be understood that, the memory in the embodiments of the present application may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which functions as an external cache. Description is illustrative but not restrictive, RAM in many forms may be available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM, an enhanced synchronous dynamic random access memory (Enhanced SDRAM, ESDRAM), a synchronous connection dynamic random access memory (Synchlink DRAM, SLDRAM) and a direct Rambus random access memory (Direct Rambus RAM, DR RAM).

Description of the above memory is illustrative but not restrictive. For example, the memory in the embodiments of the present application may also be a static random access memory (SRAM), a dynamic random access memory (DRAM), a synchronous dynamic random access memory (SDRAM), a double data rate synchronous dynamic random access memory (DDR SDRAM, an enhanced synchronous dynamic random access memory (ESDRAM), a synchronous connection dynamic random access memory (SLDRAM) and a direct Rambus random access memory (DR RAM) and the like. That is, the memory in the embodiments of the present application is intended to include, but is not limited to, these and any memory in other suitable types.

FIG. 13 is a schematic structural diagram of a communication system 1300 according to an embodiment of the present application. As shown in FIG. 13, the communication system 1300 includes a network device 1310 and a terminal device 1320.

The network device 1310 and the terminal device 1320 are configured to: determine a first SSB position based on an SSB transmission period, where the first SSB position is configured to transmit a first SSB; determine a second SSB position in candidate SSB positions within a Discovery Reference Signal DRS window, where the second SSB position is configured to transmit a second SSB; and if the first SSB position and the second SSB position overlap in a time domain, determine an SSB transmission mode of an overlapped SSB position.

Or, the network device 1310 and the terminal device 1320 are configured to: perform receiving or sending of an SSB according to a length of a discovery reference signal DRS window and an SSB transmission period.

The network device 1310 may be configured to implement corresponding functions implemented by the network device of the above method 300, and composition of the network device 1310 may be as shown in the communication device 900 of FIG. 9. It is not described herein for simplicity.

The terminal device 1320 may be configured to implement corresponding functions implemented by the terminal device of the above method 800, and composition of the terminal device 1320 may be as shown in the communication device 1000 of FIG. 10. It is not described herein for simplicity.

An embodiment of the present application further provides a computer readable storage medium for storing a computer program. In an embodiment, the computer readable storage medium may be applied to a network device in the embodiments of the present application, and the computer program may cause a computer to execute corresponding processes implemented by the network device in various methods in the embodiments of the present application. It is not described herein for simplicity. In an embodiment, the computer readable storage medium may be applied to a terminal device in the embodiments of the present application, and the computer program may cause a computer to execute corresponding processes implemented by the terminal device in various methods in the embodiments of the present application. It is not described herein for simplicity.

An embodiment of the present application further provides a computer program product which includes computer program instructions. In an embodiment, the computer program product may be applied to a network device in the embodiments of the present application, and the computer program instructions may cause a computer to execute corresponding processes implemented by the network device in various methods in the embodiments of the present application. It is not described herein for simplicity. In an embodiment, the computer program product may be applied to a terminal device in the embodiments of the present application, and the computer program instructions may cause a computer to execute corresponding processes implemented by the mobile terminal/the terminal device in various methods in the embodiments of the present application. It is not described herein for simplicity.

An embodiment of the present application further provides a computer program. In an embodiment, the computer program may be applied to a network device in the embodiments of the present application, when the computer program is run on a computer, the computer may be caused to execute corresponding processes implemented by the network device in various methods in the embodiments of the present application. It is not described herein for simplicity. In an embodiment, the computer program may be applied to a terminal device in the embodiments of the present application, when the computer program is run on a computer, the computer may be caused to execute corresponding processes implemented by the mobile terminal/the terminal device in various methods in the embodiments of the present application. It is not described herein for simplicity.

It should be understood that, the terms “system” and “network” are often used interchangeably herein. The term “and/or” herein is merely an association relationship describing an associated object, and indicates that there may be three relationships. For example, A and/or B may indicate that there are three cases: A alone, A and B together, and B alone. In addition, the character “/” herein generally indicates that the front and back associated objects are of a “or” relationship.

It should also be understood that, in the embodiments of the present application, “B corresponding to (corresponds to) A” means that B is associated with A, and B may be determined according to A. However, it should also be understood that, determining B according to A does not mean that B is determined only according to A, and B may also be determined according to A and/or other information.

Persons of ordinary skill in the art may realize that, the units and algorithm steps described in the embodiments disclosed herein may be implemented in electronic hardware, or a combination of computer software and electronic hardware. Whether these functions are executed in a manner of hardware or software depends on the particular application and design constraints of the technical solution. Professionals may use different methods for each particular application to implement the described functions, but such implementations should not be considered to be beyond the scope of the present application.

A person skilled in the pertinent art may clearly understand that, for the convenience and simplicity of description, the specific working processes of the systems, apparatuses and units described above may refer to the corresponding processes in the foregoing method embodiments, and are not described herein again.

In the several embodiments provided in the present application, it should be understood that, the disclosed systems, apparatuses and methods may be implemented in other manners. For example, the apparatus embodiments described above are merely schematic. For example, the division of the units is merely a logical function division, and there may be another division manner in an actual implementation. For example, a plurality of units or components may be combined or integrated in another system, or some features may be ignored or not performed. In another point, the displayed or discussed coupling to each other or direct coupling or a communication connection may be through some interfaces. Indirect coupling or a communication connection of the devices or the units may be electrical, mechanical or in other forms.

The units described as separate components may or may not be physically separate, and the components displayed as units may or may not be physical units, that is, may be located in one place, or may be distributed to a plurality of network units. Some or all of the units may be selected according to actual needs to achieve the purpose of the solution of the present embodiment.

In addition, each functional unit in each embodiment of the present application may be integrated in one processing unit, or each unit may be physically present separately, or two or more units may be integrated in one unit.

The function may be stored in a computer readable storage medium if it is implemented in the form of a software function unit and sold or used as an independent product. Based on such understanding, the technical solutions of the present application, or a part contributing to the prior art, or a part of the technical solutions may be embodied in the form of a software product essentially. The computer software product is stored in a storage medium, which includes some instructions for enabling a computer device (which may be a personal computer, a server, or a network device, etc.) to execute all or part of the steps of the method described in each embodiment of the present application. The foregoing storage medium includes: a U disk, a mobile hard drive, a read-only memory (ROM), a random access memory (Random Access Memory, RAM), a disk, or a compact disk, and any other medium that can store program codes.

The above are merely specific embodiments of the present application, but the protection scope of the present application is not limited thereto. Any variation or replacement readily conceivable by a person skilled in the art within the technical scope disclosed in the present application should be covered within the protection scope of the present application. Therefore, the protection scope of the present application should be defined by the protection scope of the claims.

What is claimed is:

1. A method for determining a synchronization signal block (SSB) transmission mode, the method comprising:
determining a first SSB position based on an SSB transmission period, wherein the first SSB position is configured to transmit a first SSB;
determining a second SSB position in candidate SSB positions within a discovery reference signal (DRS) window, wherein the second SSB position is configured to transmit a second SSB; and
if the first SSB position and the second SSB position overlap in a time domain, determining an SSB transmission mode of an overlapped SSB position.

2. The method according to claim 1, wherein the determining the SSB transmission mode of the overlapped SSB position comprises at least one of:
if transmission of at least one round of SSBs has been completed before the overlapped SSB position within the DRS window, determining that the overlapped SSB position is not configured to perform transmission of an SSB; and
if the transmission of the at least one round of SSBs has not been completed before the overlapped SSB position within the DRS window, determining that the overlapped SSB position is configured to transmit the second SSB.

3. The method according to claim 1, wherein the determining the SSB transmission mode of the overlapped SSB position comprises:
determining that the overlapped SSB position is configured to transmit the second SSB.

4. The method according to claim 1, wherein the determining the SSB transmission mode of the overlapped SSB position comprises:
determining that the overlapped SSB position is configured to transmit the first SSB.

5. The method according to claim 1, wherein the determining the SSB transmission mode of the overlapped SSB position comprises at least one of:
if transmission of at least one round of SSBs has been completed before the overlapped SSB position within the DRS window, determining that the overlapped SSB position is configured to transmit the first SSB; and
if the transmission of the at least one round of SSBs has not been completed before the overlapped SSB position within the DRS window, determining that the overlapped SSB position is configured to transmit the second SSB.

6. The method according to claim 1, wherein the determining the SSB transmission mode of the overlapped SSB position comprises at least one of:
if the first SSB and the second SSB have different quasi-co-location (QCL) relationships, determining that the overlapped SSB position is not configured to perform sending of an SSB; and
if the first SSB and the second SSB have a same QCL relationship, determining that the overlapped SSB position is configured to send the first SSB or the second SSB.

7. The method according to claim 1, wherein a length of the SSB transmission period is 5 ms.

8. The method according to claim 1, wherein a length of the DRS window is greater than 5 ms.

9. A method for determining a synchronization signal block (SSB) transmission mode, the method comprising:
performing receiving or sending of an SSB according to a length of a discovery reference signal (DRS) window and an SSB transmission period.

10. The method according to claim 9, wherein if the length of the DRS window is greater than 5 ms,
a length of the SSB transmission period is not equal to 5 ms, or, a length of the SSB transmission period being equal to 5 ms is invalid configuration, or, a length of the SSB transmission period is greater than or equal to the length of the DRS window, or, SSB transmission of which a length of the SSB transmission period is equal to 5 ms is not performed within the DRS window.

11. The method according to claim 9, wherein the length of the DRS window is 6 ms, 7 ms, 8 ms or 9 ms.

12. The method according to claim 9, wherein if a length of the SSB transmission period is equal to 5 ms,
the length of the DRS window is not greater than 5 ms, or the length of the DRS window is greater than 5 ms and a part being greater than 5 ms is not configured to perform the sending of the SSB within the DRS window.

13. A communication device, wherein the communication device comprises a processor and a memory, wherein the memory is configured to store a computer program, and the processor is configured to invoke and run the computer program stored in the memory, so as to:
determine a first synchronization signal block (SSB) position based on an SSB transmission period, wherein the first SSB position is configured to transmit a first SSB;
determine a second SSB position in candidate SSB positions within a discovery reference signal (DRS) window, wherein the second SSB position is configured to transmit a second SSB; and
if the first SSB position and the second SSB position overlap in time domain, determine an SSB transmission mode of an overlapped SSB position.

14. The communication device according to claim 13, wherein the processor is configured to at least one of:
if transmission of at least one round of SSBs has been completed before the overlapped SSB position within the DRS window, determine that the overlapped SSB position is not configured to perform transmission of an SSB; and
if the transmission of the at least one round of SSBs has not been completed before the overlapped SSB position within the DRS window, determine that the overlapped SSB position is configured to transmit the second SSB.

15. The communication device according to claim 13, wherein the processor is configured to:
determine that the overlapped SSB position is configured to transmit the second SSB.

16. The communication device according to claim 13, wherein the processor is configured to:
determine that the overlapped SSB position is configured to transmit the first SSB.

17. The communication device according to claim 13, wherein the processor is configured to at least one of:
if transmission of at least one round of SSBs has been completed before the overlapped SSB position within the DRS window, determine that the overlapped SSB position is configured to transmit the first SSB; and
if the transmission of the at least one round of SSBs has not been completed before the overlapped SSB position within the DRS window, determine that the overlapped SSB position is configured to transmit the second SSB.

18. A communication device, wherein the communication device comprises a processor and a memory, wherein the memory is configured to store a computer program, and the processor is configured to invoke and run the computer program stored in the memory, so as to execute the method according to claim 9.

19. A computer readable storage medium configured to store a computer program, and the computer program is configured to cause a computer to execute the method according to claim 1.

20. A computer readable storage medium configured to store a computer program, and the computer program is configured to cause a computer to execute the method according to claim 9.
